(19) United States
(12) Patent Application Publication
(10) Pub. No.: US 2017/0165146 A1
(43) Pub. Date: Jun. 15, 2017

(54) MEDICAL KNEE WALKER

(71) Applicants: Justin Franson, Austin, TX (US); Suzanne Carr Tan Hawson, Valencia, CA (US)

(72) Inventors: Justin Franson, Austin, TX (US); Suzanne Carr Tan Hawson, Valencia, CA (US)

(21) Appl. No.: 15/380,394

(22) Filed: Dec. 15, 2016

Related U.S. Application Data
(60) Provisional application No. 62/267,408, filed on Dec. 15, 2015.

(51) Int. Cl. A61H 3/04; B62K 5/05; B62K 23/06; B62K 5/06; B62K 5/023; B62K 5/08

(52) U.S. Cl. CPC A61H 3/04; B62K 5/023; B62K 5/08; B62K 23/06; B62K 5/06; B62K 5/05; A61H 2003/005

(57) ABSTRACT

A knee walker for use as a walking aid by disabled persons includes multiple wheels operably coupled to a frame and a steering assembly. A knee pad is supported by the frame intermediate front and rear wheels to support a user's bent knee and lower leg thereon. A suspension or shock absorbing assembly is disposed intermediate the knee rest pad and the frame. The knee walker is adjustable to accommodate users of varying sizes.

### RELATED APPLICATION

This application claims priority to U.S. Provisional Application Ser. No. 62/267,408, filed Dec. 15, 2016.

### BACKGROUND OF THE INVENTION

The present invention generally relates to the field of ambulatory assistive devices for the physically impaired. More particularly, the present invention relates to a knee mobility walker for aiding the disabled in walking.

In situations where an individual has injured, or had a surgical procedure on, a lower portion of the leg, ankle or foot, it is preferred medically to keep weight off of the lower leg or foot while recuperating. Traditionally, this has been achieved by the use of wheelchairs or crutches.

A wheelchair is generally prescribed for patients who do not have the balance, strength or stability to use crutches or a walker. However, medical studies have demonstrated that a wheelchair can contribute to a deterioration of cardiovascular health, strength and overall energy. Doctors and patients alike recognize that the earlier a patient is able to be mobile and stay out of a wheelchair, the more progress a patient makes toward his or her recovery. Moreover, wheelchairs can be undesirable for reasons such as transporting the wheelchair and limited access during use.

Traditionally, doctors have recommended crutches when a patient is required to keep their bearing weight off of a foot or leg. Unfortunately, crutches exhibit a number of requirements and restrictions, including requiring the patient to maintain their balance, hold up the weight of the injured leg, and require the patient to constantly shift their weight back and forth to move forward. Crutches can be difficult to maneuver on uneven or loose ground. Sore or bruised body tissue, sprained and sore wrists and a propensity for falling also typically go hand-in-hand with the use of crutches. Moreover, anyone with a history of shoulder injury or surgery, breast cancer, wrist injury or surgery, or certain other conditions, may be restricted from the use of crutches.

Knee walkers, also referred to as knee scooters or knee rollers, have become increasingly popular in recent years as canes, crutches and the like have been found inconvenient and unstable for certain persons with leg, foot and ankle injuries or ailments. Such knee walkers typically provide more stability and mobility than crutches, a walker or a wheelchair. The knee walker will generally have wheels attached to a frame and a pad supported by the frame intermediate the front and back wheels so as to allow the user to rest his or her injured leg on the pad and use his or her non-injured leg to propel the device across a surface. The knee walker's wheels and user's ability to maintain one leg on the ground during use adds to the stability and mobility of the knee walker. Such knee walkers have been advantageous to assist in easier and safer mobility and for traveling longer distances.

While the benefits of knee walkers are a significant improvement over crutches, walkers and wheelchairs, prior art knee walkers have several shortcomings and drawbacks. Bumps and the like caused by uneven surfaces transmit forces up through the frame and into the user's knee which is rested on the knee pad. This can cause discomfort and even pain over time. Moreover, while the patients using such knee walkers vary significantly in size, prior art knee walkers are limited in their adjustability to accommodate the sizes of such users.

Accordingly, there is a continuing need for an improved knee walker which provides suspension between the frame and knee resting pad of the walker and which is easily adjustable to accommodate patients of varying size. The present invention fulfills these needs, and provides other related advantages.

### SUMMARY OF THE INVENTION

The present invention resides in a knee walker for use as a walking aid by disabled persons. The knee walker generally comprises a frame having at least three wheels comprising front and rear wheels operably coupled to the frame. A steering assembly is operably coupled to at least one of the wheels. The steering assembly comprises a handlebar rotatably disposed within a steering tube of the frame. The at least three wheels may comprise two wheels operably coupled to the steering assembly and a front portion of the frame. A single rear wheel may be coupled to a rear portion of the frame. The frame may be offset such that the rear wheel is generally aligned with the steering tube of the frame.

The knee pad is supported by the frame intermediate the front and rear wheels. The knee pad is configured to support a user's bent knee and lower leg thereon. Typically, the user utilizes his or her other leg and foot to propel the knee walker. The knee pad includes an elongated depression formed in a top portion thereof. The depression is configured to receive a knee and at least a portion of a lower leg of the user.

A suspension assembly is disposed intermediate the knee rest pad and the frame. The suspension assembly in a particularly preferred embodiment comprises a telescopic mechanism having a damper between the knee rest pad and the frame. The suspension assembly may comprise a suspension seat post. The suspension seat post may comprise a hydraulic piston or a pneumatic piston.

The knee walker typically also includes a hand brake assembly for controllably stopping the knee walker. The hand brake assembly includes a brake cable which extends to a brake caliper of a disc brake. Preferably, the brake cable extends through at least a portion of the frame.

The knee walker also preferably includes an adjustment mechanism for selectively adjusting the distance between the knee pad and the frame.

The frame of the knee walker may also include a foot rest platform between the front wheels. The platform is disposed at an angle of approximately ten degrees to thirty degrees towards the user. This enables the user to comfortably rest his or her foot on the foot rest platform when seated on the knee pad, such as when stopped and resting or the like.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a side perspective view of a medical knee walker embodying the present invention;

FIG. 2 is a side perspective view of the knee walker of FIG. 1, but in a folded and compact state;

FIG. 3 is a side view of the knee walker of the present invention illustrating a user operating the knee walker, in accordance with the present invention;

FIG. 4 is an enlarged perspective view of area “4” of FIG. 1, illustrating a brake cable entering a frame of the knee walker, in accordance with the present invention;

FIG. 5 is an enlarged perspective view of area “5” of FIG. 1, illustrating the brake cable exiting from the frame to a brake caliper, in accordance with the present invention;

FIG. 6 is a cross-sectional view of a knee pad of the knee walker;

FIG. 7 is a bottom perspective view of the knee pad and a height adjustment mechanism of the knee walker;

FIG. 8 is a partially sectioned perspective view, illustrating a suspension assembly disposed intermediate the knee rest pad and frame of the knee walker, in accordance with the present invention; and

FIG. 9 is a rear elevational and diagrammatic view of the knee walker, illustrating the offset frame and alignment of a rear wheel with a steering tube of the frame, in accordance with the present invention.

### DETAILED DESCRIPTION OF THE PREFERRED EMBODIMENTS

As shown in the accompanying photographs and drawings, for purposes of illustration, the present invention is directed to an improved medical knee walker, referred to generally by the reference number 10. As will be more fully described herein, the knee walker 10 of the present invention overcomes problems and drawbacks of prior medical knee walkers, including providing increased height adjustability and knee pad suspension.

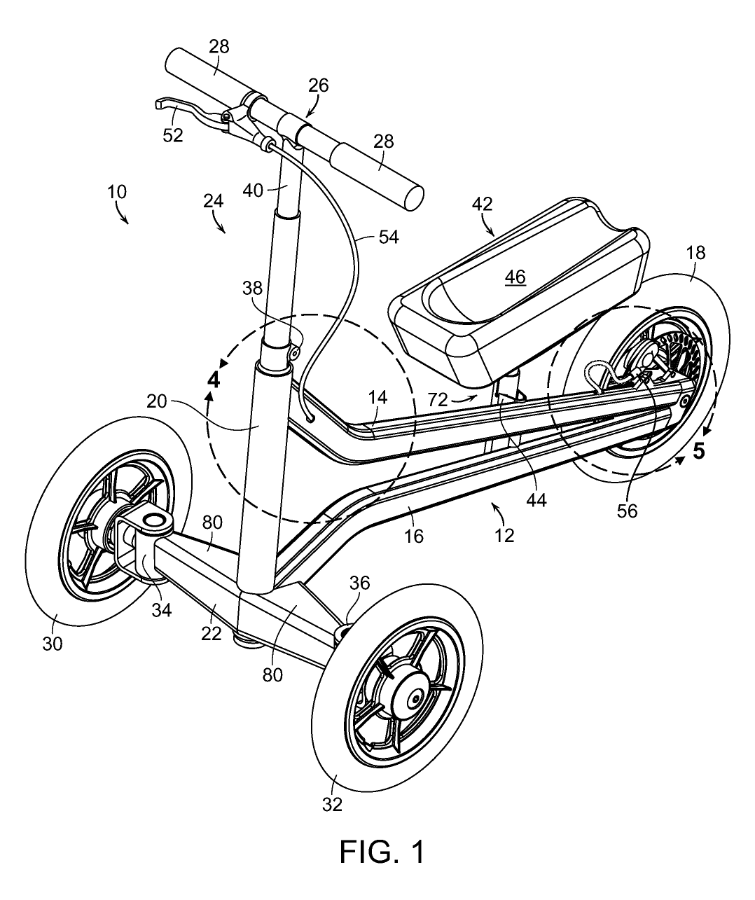

With reference now to FIG. 1, a knee walker 10 embodying the present invention is shown. The knee walker 10 of the present invention is specifically designed as a medical device for those who have a lower leg, ankle or foot injury, have had surgery on these areas of the body, or for amputees of these body parts or have other ailments affecting these body parts.

The knee walker 10 includes a frame 12. As illustrated in the various figures herein, the frame 12 may be comprised of generally tubular or hollow members which are operably joined to one another, such as by welding, or the frame may be created by molding techniques or the like. As illustrated, the frame 12 includes an upper frame member 14 and a lower frame member 16.

The knee walker 10 includes a plurality of wheels to support the frame 12 and provide mobility to the knee walker 10. Typically, as illustrated, there are at least three wheels, although the invention contemplates utilizing four wheels. Utilizing three or four wheels provides stability to the knee walker 10 which is important for those utilizing the knee walker 10 who have a medical condition and need the knee walker 10 for support and mobility. The wheels may be inflated with air, enabling rubber to be utilized for the tires and provide sufficient grip and also providing a degree of dampening due to uneven surfaces across which the knee walker 10 is passed.

In a particularly preferred embodiment, as illustrated, the upper and lower frame members 14 and 16 are joined to one another or otherwise adjacent thereto at one end where a rear wheel 18 is attached to the frame 12. Opposite ends of the upper and lower frame members 14 and 16 diverge from one another due to bends within the frame members 14 and 16 so as to connect to a generally vertical steering tube 20 of the frame. A lower end of the steering tube 20 and an end of the lower frame member 16 are coupled to an axle cross member 22 which extends in a generally horizontal plane.

A steering assembly 24 includes a handlebar 26 rotatably disposed within the steering tube 20 of the frame 12. The handlebar 26 typically has hand grips 28 at ends thereof which can be easily and comfortably gripped by the user of the knee walker 10. Pushing or pulling the hand grips 28 causes the handlebar 26 to rotate within the steering tube 20 of the frame 12 and pivot and change the angle of front wheels 30 and 32 which are operably coupled to the steering assembly 24. The front wheels 30 and 32 are typically coupled to generally opposite ends of the crossbar 22 and operably connected to the steering mechanism 24, such as by tie bars, linkages or the like which interconnect the handlebar 26 and the wheels 30 and 32. Axle wheel assemblies 34 and 36 may be utilized which are pivotally attached to the axle crossmember 22 of the frame 12 and the front wheels 30 and 32, and which rotate or pivot as the handlebar 26 is rotated. The wheels 30 and 32 are typically rotatably coupled, such as by an axle or the like, to the axle wheel assemblies 34 and 36. Assemblies and mechanisms for transferring rotational movement of a handlebar to one or more wheels are well known and can be incorporated in the present invention, and thus it will be appreciated that other types of handlebar assembles and steering mechanisms and assemblies can be incorporated into the present invention so as to enable the knee walker 10 to be controllably turned. Preferably, however, there are two wheels 30 and 32 at the front of the knee walker 10 so as to provide stability and support while the user is operating the knee walker 10, such as preventing the knee walker 10 from tipping over easily during use.

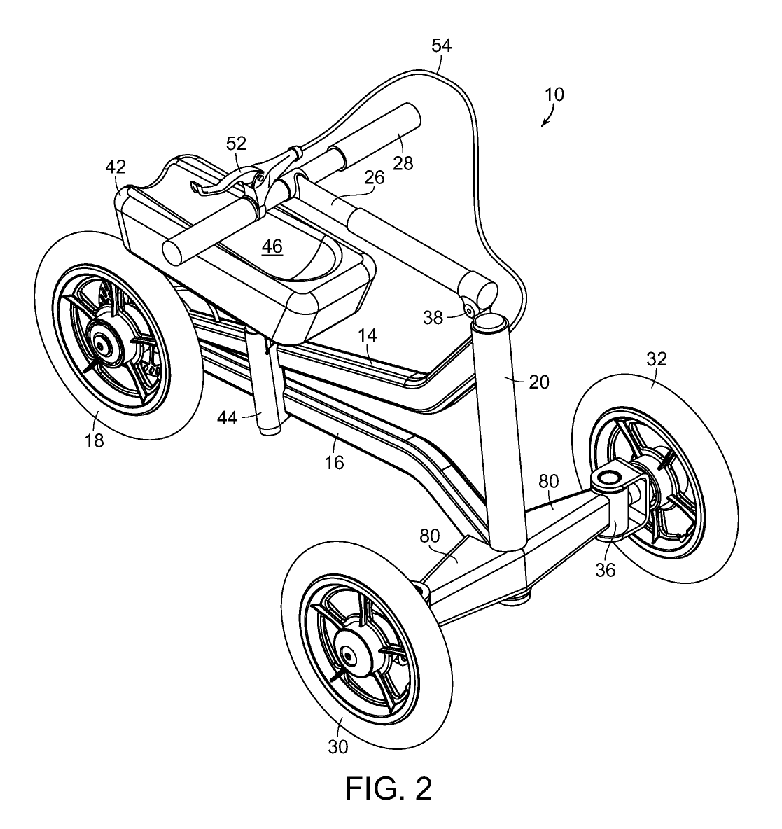

With reference now to FIGS. 1 and 2, the present invention contemplates the adjustability of the handlebar 26 relative to the user so as to raise or lower the handles or grips 28 to provide comfort and convenience to the user. This can be done, for example, by means of an adjustable clamp 38, which upon being loosened allows the vertical tube or shaft 40 or the handlebar 26 to be raised and lowered within the steering tube 20 of the frame 12. In a particularly preferred embodiment, the adjustment means comprises a quick lever clamp 38 which enables the handlebar tube 40, which is telescopically received within the steering tube 20 to be raised and lowered, as needed. In one embodiment, as illustrated in FIG. 2, the handlebar 26 is also pivotally connected to the frame 12, such that it can be pivotally lowered, as illustrated in FIG. 2, for transporting and storing the knee walker 10, or raised uprightly, as illustrated in FIG. 1 when in use.

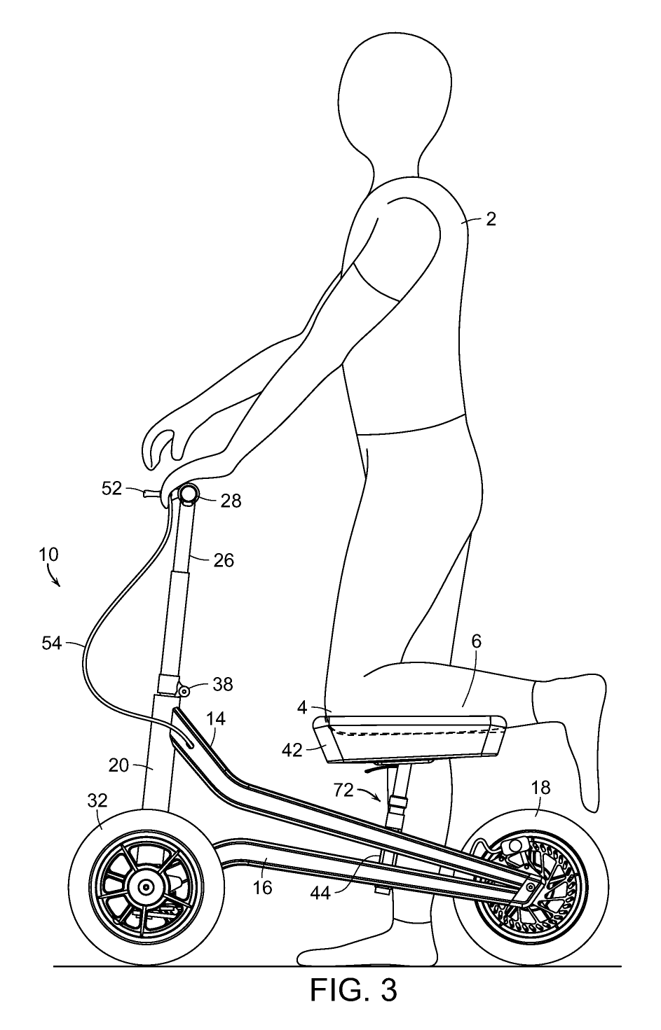

A knee supporting or rest pad 42 is attached to the frame 12, such as by a support tube 44. The knee pad 42 is of such a width and length so as to be able to place one's knee and a portion of the lower leg thereon to support, balance and stabilize the individual on the knee walker 10, as illustrated in FIG. 3. As mentioned above, typically the user operating the knee walker 10 device will have an injury to his or her foot, ankle or lower leg, such as the result of an accident, surgery, or the like, which prevents the user 2 from placing weight on his or her foot, ankle, and/or lower leg and thus prevents the user from walking on that foot and/or leg. Placing the knee 4 and portion of the lower leg 6 onto the knee rest supporting pad 42 enables the user 2 to suspend his or her ankle and foot and lowermost portion of the leg so that pressure is not exerted thereon.

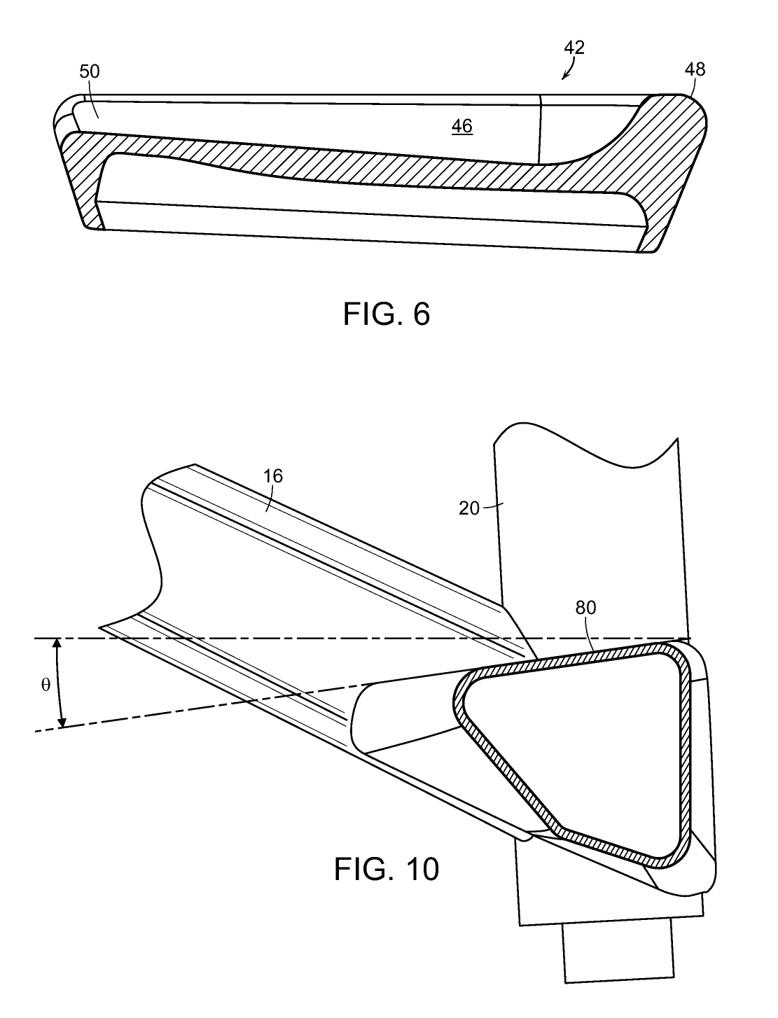

Preferably, the knee rest support 42 is comprised of foam or other cushion material so as to provide comfort. As illustrated in FIGS. 1-3 and 6, in a particularly preferred embodiment, the knee rest pad 42 is designed so as to have a depression 46 formed therein on a top surface thereof such that the knee and lower leg can fit within the depression. However, the front 48 of the knee pad 50 does not have the depression, so that the knee of the user does not slide forward off of the knee rest pad 42, such as when stopping the knee walker 10. However, the rear end 50 of the knee rest pad 42 does have the depression and an opening, such that the lowermost portion of the leg, ankle and foot can extend therefrom, as illustrated in FIG. 3.

With reference now to FIG. 3, in use, the user 2 places one of his or her knees 4 and lower legs 6 onto the knee rest pad 42 with the other foot on the ground or floor surface, as illustrated. The user 2 grasps the hand grips 28 of the handlebar 26 in order to be able to steer the knee walker 10. The user 2 then utilizes his or her foot in contact with the ground to repeatedly push so as to propel the knee walker 10, and thus the user 2, forward.

With reference to FIGS. 1-5, the knee walker 10 preferably includes a brake assembly for selectively slowing or stopping the knee walker 10 when in use. The brake assembly includes at least one manual brake lever 52 which is connected to a brake cable 54 which extends from the lever 52 to a brake mechanism 56 disposed adjacent to one or more of the wheels for stopping the rotation of the wheel. Although a variety of different types of brakes could be used in accordance with the present invention, in a particularly preferred embodiment, a disc 58 is coupled to the rear wheel 18 so as to rotate therewith and the braking mechanism comprises a pair of calipers and/or brake pads 60, which are brought into contact with the brake disc 58 as the brake lever 52 is actuated by the user, causing the brake cable 54 to actuate the caliper 60, causing the pads to come into contact with the disc 58 of the disc brake, causing the rear wheel 18 to increasingly slow down and stop, and thus the knee walker 10 to stop. The use of disc brakes increases performance and provides durability.

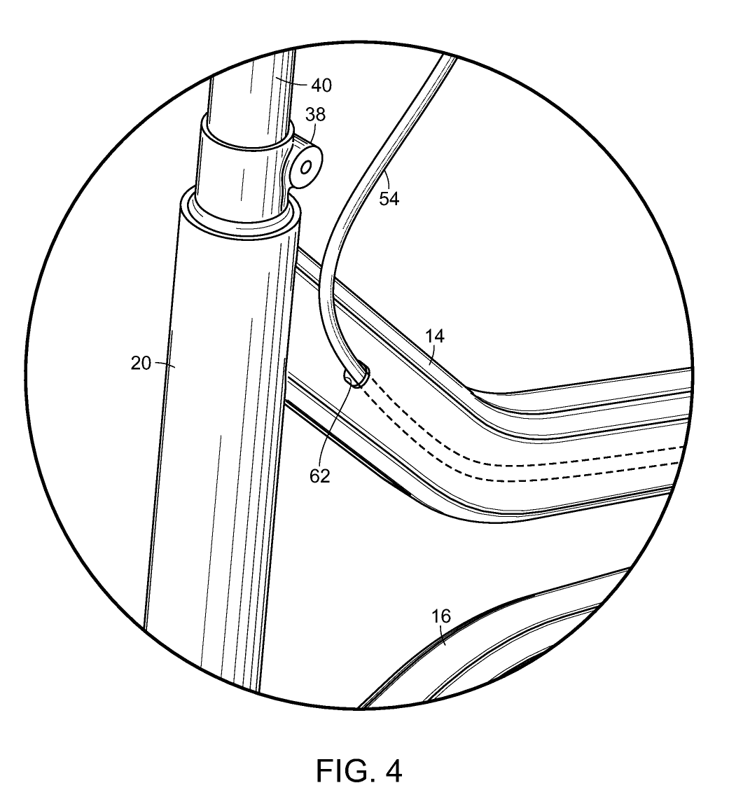

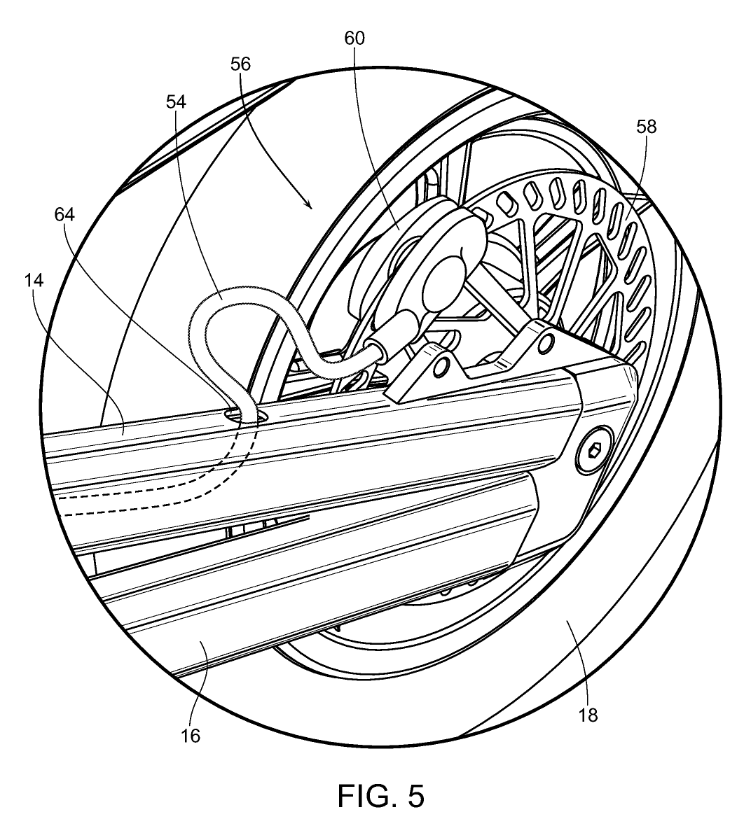

As illustrated in FIGS. 4 and 5, preferably, the brake cable 54 enters into the frame 12, such as the upper frame 14 through aperture 62 and extends through the hollow frame member 14 until it exits aperture 64 adjacent to the brake mechanism 56. Aside from being visually appealing, this protects the brake cable 54 from being caught on objects which come into contact with the frame.

The three-wheeled design of the present invention provides inherent benefits. The braking system is able to be coupled only to a single rear wheel 18, resulting in manufacturing cost savings. In a four-wheel configuration two different sets of brake mechanisms would have to be associated with the rear wheels in order to avoid a sudden pulling movement to the left or right as the walker is stopped, which could cause instability of the walker. Having a single rear wheel 18 enables the overall footprint and size of the knee walker 10 to be smaller. Moreover, the knee walker 10 is able to be manufactured with only three wheels, instead of four wheels.

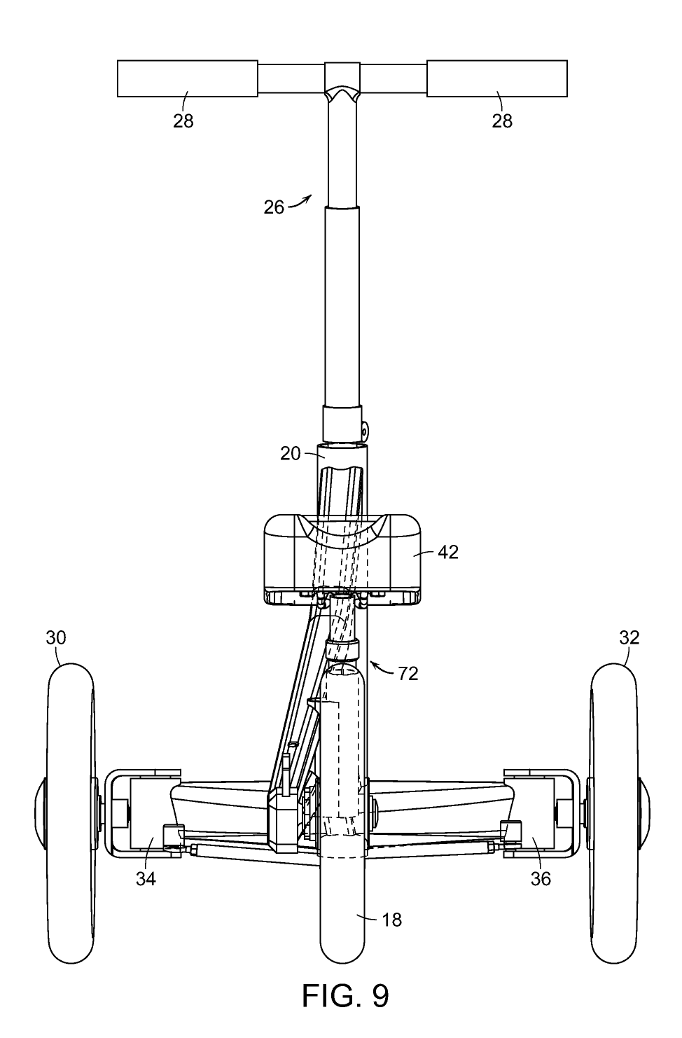

With reference now to FIG. 9, in a particularly preferred embodiment, the frame is angularly offset, as illustrated, such that the front end of the frame and the rear end of the frame do not lie generally in the same plane, but instead the rear end of the frame is offset at a predetermined angle. That is, the rear end of the frame 12 which is coupled to the rear wheel 18 is offset to either the right or the left in order to center and align the rear wheel 18, as well as the knee rest pad 42, with the steering tube 20 and handlebar 26. This provides additional stability and control to the knee walker 10.

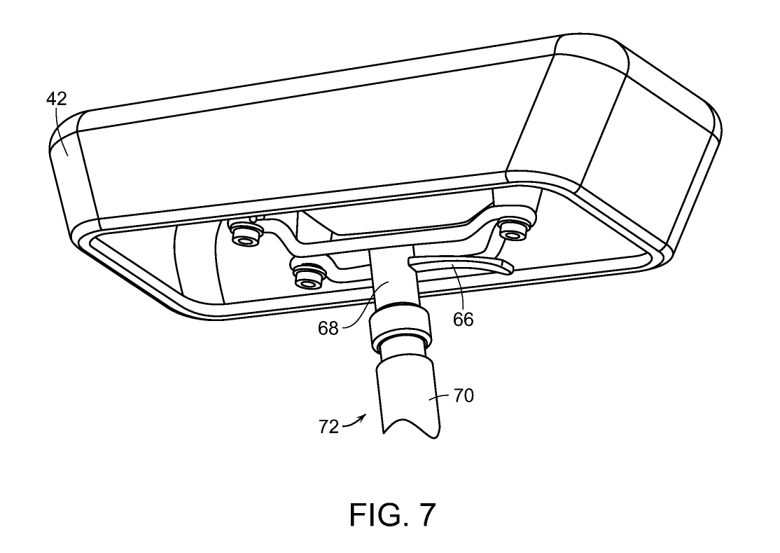

The knee walker 10 of the present invention is also adjustable to accommodate users of different sizes. Adjustment clamp 38 can be actuated in order to enable the user to raise or lower the handlebar 26, such as by means of the handlebar tube 40 being raised and lowered in a telescopic manner with respect to an outer tube, such as the steering tube 20 or an intermediate tube. Moreover, the knee rest pad 42 may be selectively raised and lowered. As illustrated in FIG. 7, a quick adjust lever 66 can be actuated by the user, such as by lifting up on the lever 66, in order to move the seat post 68, and thus the knee rest pad 42 upwardly or downwardly. The seat post tube 68 is telescopically received within an outer tube 70, and lifting the quick adjust lever 66 enables the seat post tube 68 to be raised and lowered in any desired increment and to any height within the range of the tubes 68 and 70. Releasing the lever 66 will automatically lock the tubes 68 and 70 in place with respect to one another, and thus lock the height of the knee rest pad 42 in place. Thus, the knee rest pad 42 can be adjusted upwardly and downwardly to meet the desired height for any individual's needs as the adjustment mechanism allows for endless iterations of height. In prior art knee walkers, there is either no height adjustability or limited height adjustability by a series of preset spaced apertures and a spring-loaded pin, requiring the height adjustment to be in increments of height in accordance with the spacing of the apertures. However, in accordance with the present invention, the adjustment mechanisms of the present invention allows for selectively adjusting the distance between the knee pad 42 and the frame 12 in any desired increment within the range of movement between the posts and the adjustment mechanism.

The adjustability of the knee rest pad 42 also enables the knee walker 10 to be moved into a more compact state for transport and/or storage. The knee rest pad 42 would be lowered to its lowermost state. The handlebar 26 would be lowered to its most lowered state and/or folded downwardly, such as by actuating handlebar adjustment clamp 38, as illustrated in FIG. 2. This more compact state enables the knee walker 10 to be more easily placed in an automobile for transport or stored when not in use.

With reference now to FIGS. 1-3,7 and 8, in accordance with the present invention a suspension assembly 72 is disposed between the knee resting pad 42 and the frame 12. This allows the knee support pad 42 to have a limited amount of vertical travel to provide comfort to the user's knee and leg as the user pushes his or her weight onto the knee support pad 42, encounters uneven surfaces and the like. Such forces are dissipated by a shock absorber or suspension of the suspension assembly 72.

In a particularly preferred embodiment, the suspension is disposed immediately below the knee rest support pad 42, such as being incorporated into the knee rest stem between the knee support pad 42 and the frame 12 of the device 10, such that the forces that would otherwise be transferred directly up into the knee support pad 42 will be dissipated. For example, the suspension assembly 72 may comprise a telescopic mechanism having a damper between the knee rest pad 42 and the frame 12. Preferably, the suspension device is incorporated within the tubing of the stem. Such suspension devices may be spring-based, elastomeric, or in a particularly preferred embodiment pneumatic.

With reference to FIG. 10, a pneumatic suspension device embodying the present invention is shown. The suspension assembly 72 comprises a rod 74 having a piston 76 coupled to an end thereof. The movement of the rod 74 will correspond with the movement of the knee rest pad 42, such as by being connected to stem tube 68, the knee rest pad 42 directly, or intermediate components and linkages and the like. Movement of the piston 76 is dampened by virtue of air, or hydraulic fluid, which is compressed and decompressed as the frame 12 travels upwardly and downwardly as the knee walker 10 travels across uneven surfaces.

As illustrated in FIGS. 1-3, the outer tube 70 of the suspension assembly 72 resides within the frame tube 44. Thus, as the frame 12, and thus the frame tube 44 moves upwardly and downwardly due to travel of the knee walker 10 across uneven surfaces, these forces are transmitted through the suspension assembly causing the rod 74 and the piston 76 to travel upwardly and downwardly, and to dampen these forces as they are transmitted to the knee rest pad 42, such that the knee rest pad 42 travels upwardly and downwardly, but the forces are dampened and dissipated by means of the compression and decompression of the air or hydraulic fluid 78 or the like within the suspension assembly 72.

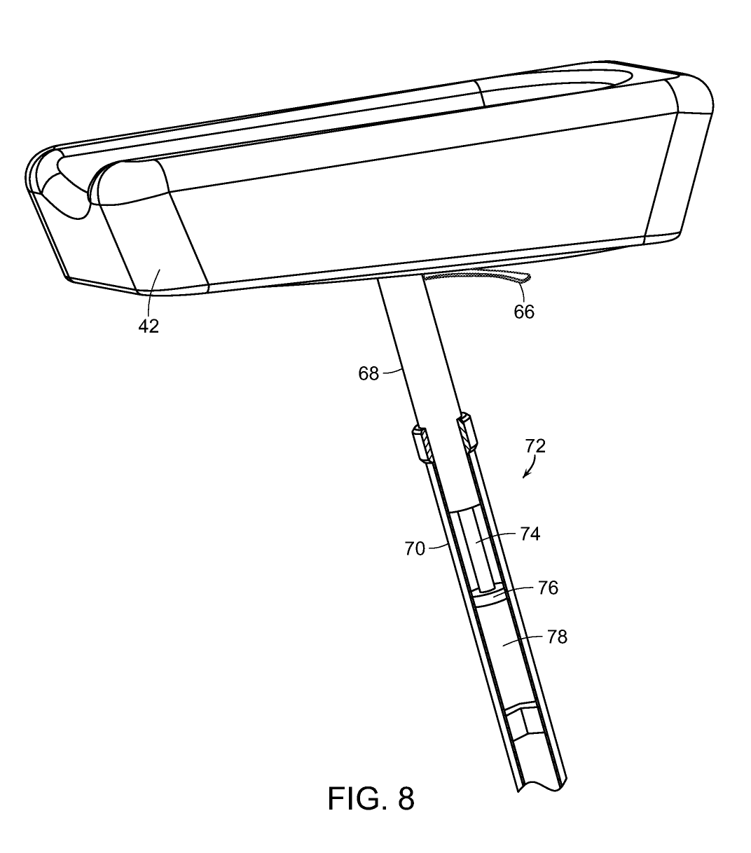

It will be understood that in place of a hydraulic or pneumatic piston arrangement, as illustrated in FIG. 8, a coiled spring or a compressible elastomeric pad or the like could alternatively be used. However in a particularly preferred embodiment, the suspension assembly 72 comprises a suspension seat post, as illustrated in FIG. 8, interconnecting the knee rest pad 42 and frame 12. The important aspect of the present invention is that the upward and downward forces that would otherwise be transferred through the knee rest support pad 42 be dampened to provide comfort to the user of the knee walker 10.

It will be appreciated that the knee walker 10 can be used over prolonged periods of time as the individual is using the knee walker 10 in lieu of walking from location to location. This can create stress on the individual's knee and leg as he or she utilizes the walker 10 throughout the course of the day. Moreover, either due to the individual's lower leg, ankle or foot ailment, surgery, or the like forces that would otherwise be transmitted through the knee rest pad 42 could potentially cause pain to the area where the surgery was performed, the ailment or injury is or the like and be felt much more profoundly by such individuals if not dampened by the suspension assembly 72 of the present invention. While suspension devices could be placed associated with the wheels or the handlebar assembly, it is believed that these placements would not be nearly as effective in reducing the forces transmitted to the user's knee and lower leg, foot, etc. as the placement directly below the knee support pad 42, as in the present invention. By placing the suspension in the vertical path of the weight bearing portion of the knee rest pad 42 provides the most relief of discomfort and dampening of stress transmitted at the contact point. This greatly reduces the hot spot sensation that many patients feel as they use other knee walkers for any prolonged period of time.

There are times when the user will sit on the knee rest pad 42, such as when stopped for a period of time and resting, waiting, or the like. It can be uncomfortable for the user to place his injured foot or ankle directly onto the ground or floor, and in many instances the user has a cast, boot, or protective bandaging surrounding the ankle and foot area. Thus, the present invention provides a foot rest platform 80 on top of the axle cross member 22. As can be seen in FIGS. 1 and 2, the foot rest platforms 80, on either side of the steering tube 20 of an enlarged area so that the user may comfortably place his or her foot thereon. As illustrated in FIG. 10, the foot rest platform has an angle ø of approximately 10°-30° such that the platform 80 is angled towards the user so that it is comfortable for the user to place is or her foot thereon. The angle of the foot rest platform 80 provides a natural resting angle for the foot and ankle so as to reduce the stress thereon. Anti-skid or other gripping material may be placed on the upper surface of the platforms 80 to prevent the user's foot from slipping off of the platform.

Although several embodiments have been described in detail for purposes of illustration, various modifications may be made without departing from the scope and spirit of the invention. Accordingly, the invention is not to be limited, except as by the appended claims.

What is claimed is:

1. A knee walker for use as a walking aid by disabled persons, comprising:
a frame;
at least three wheels comprising front and rear wheels operably coupled to the frame;
a steering assembly operably coupled to at least one of the wheels;
a knee rest pad supported by the frame intermediate the front and rear wheels, the knee pad configured to support a user's bent knee and lower leg thereon; and
a suspension assembly disposed intermediate the knee rest pad and the frame.

2. The knee walker of claim 1, wherein the suspension assembly comprises telescopic mechanism having a damper between the knee rest pad and the frame.

3. The knee walker of claim 1, wherein the suspension assembly comprises a suspension seatpost.

4. The knee walker of claim 3, wherein the suspension seatpost comprises a hydraulic piston or a pneumatic piston.

5. The knee walker of claim 1, wherein the steering assembly comprises a handlebar rotatably disposed within a steering tube of the frame.

6. The knee walker of claim 5, wherein the at least three wheels comprise two front wheel operably coupled to the steering assembly and a front portion of the frame.

7. The knee walker of claim 6, including a single rear wheel coupled to a rear portion of the frame.

8. The knee walker of claim 7, wherein the frame is offset such that the rear wheel is generally aligned with the steering tube of the frame.

9. The knee walker of claim 1, wherein the knee pad includes an elongated depression formed in a top portion thereof, the depression being configured to receive a knee and at least a portion of a lower leg of the user.

10. The knee walker of claim 1, including a hand brake assembly for controllably stopping the knee walker.

11. The knee walker of claim 10, wherein the hand brake assembly includes a brake cable extending through at least a portion of the frame to a brake caliper of a disc brake.

12. The knee walker of claim 1, including an adjustment mechanism for selectively adjusting the distance between the knee pad and the frame.

13. The knee walker of claim 1, wherein the frame includes a foot rest platform between front wheels, the platform being disposed at an angle of approximately between 10 degrees and 30 degrees towards the user.

14. A knee walker for use as a walking aid by disabled persons, comprising:
a frame;
at least three wheels comprising front and rear wheels operably coupled to the frame;
a steering assembly comprising a handlebar rotatably disposed within a steering tube of the frame and operably coupled to at least one of the wheels;
a knee rest pad supported by the frame intermediate the front and rear wheels, the knee pad having an elongated depression formed in a top surface thereof configured to support a user's bent knee and lower leg therein;
a suspension assembly comprising a telescopic suspension seatpost disposed intermediate the knee rest pad and the frame; and
a hand brake assembly for controllably stopping the knee walker.

15. The knee walker of claim 14, wherein the suspension seatpost comprises a hydraulic piston or a pneumatic piston.

16. The knee walker of claim 14, wherein the at least three wheels comprise two front wheel operably coupled to the steering assembly and a front portion of the frame.

17. The knee walker of claim 16, including a single rear wheel coupled to a rear portion of the frame.

18. The knee walker of claim 17, wherein the frame is offset such that the rear wheel is generally aligned with the steering tube of the frame.

19. The knee walker of claim 14, wherein the hand brake assembly includes a brake cable extending through at least a portion of the frame to a brake caliper of a disc brake.

20. The knee walker of claim 14, including an adjustment mechanism for selectively adjusting the distance between the knee pad and the frame.

21. The knee walker of claim 14, wherein the frame includes a foot rest platform between front wheels, the platform being disposed at an angle of approximately between 10 degrees and 30 degrees towards the user.

22. A knee walker for use as a walking aid by disabled persons, comprising:
a frame;
at least three wheels comprising front and rear wheels operably coupled to the frame;
a steering assembly comprising a handlebar rotatably disposed within a steering tube of the frame and operably coupled to at least one of the wheels;
a knee pad supported by the frame intermediate the front and rear wheels, the knee pad having an elongated depression formed in a top surface thereof configured to support a user's bent knee and lower leg therein;
an adjustment mechanism for selectively adjusting the distance between the knee pad and the frame;
a suspension assembly comprising a suspension seatpost comprising a hydraulic piston or a pneumatic piston disposed intermediate the knee rest pad and the frame; and
a hand brake assembly for controllably stopping the knee walker;
wherein the at least three wheels comprise two front wheel operably coupled to the steering assembly and a front portion of the frame and a single rear wheel coupled to a rear portion of the frame; and
wherein the frame is offset such that the rear wheel is generally aligned with the steering tube of the frame.

23. The knee walker of claim 22, wherein the hand brake assembly includes a brake cable extending through at least a portion of the frame to a brake caliper of a disc brake.

24. The knee walker of claim 22, wherein the frame includes a foot rest platform between front wheels, the platform being disposed at an angle of approximately between 10 degrees and 30 degrees towards the user.
